(19) United States
(12) Patent Application Publication
(10) Pub. No.: US 2026/0271843 A1
(43) Pub. Date: Sep. 17, 2026

(54) APPARATUS FOR SELF-WATERING PLANTS

(71) Applicant: Edgy Shelf Products, LLC, Mapleton, UT (US)

(72) Inventors: Dedee R. Dart, Mapleton, UT (US); Bart Storrs, Highland, UT (US)

(21) Appl. No.: 19/077,827

(22) Filed: Mar. 12, 2025

(51) Int. Cl. A01G 27/06; A01G 9/04

(52) U.S. Cl. CPC A01G 27/06; A01G 9/04

(57) ABSTRACT

A self-watering system for potted plants includes a saucer with a deep water reservoir, raised support structures to elevate the plant container, and one or more wicking devices that draw water from the reservoir into the container. The design prevents overflow by containing excess water and positioning the plant container such that roots are not constantly submerged. The wicking devices, which may include slow-release fertilizers, are easily inserted through the container's drainage holes. An optional set of adjustable hooks allows adaptation for hanging baskets. This invention converts virtually any standard pot into a self-watering container, reducing watering frequency and preventing damage to underlying surfaces.

### BACKGROUND OF THE INVENTION

### Field of the Invention

The present invention relates generally to plant-watering devices. More particularly, the invention relates to a self-watering plant container saucer that holds and controls water levels within a reservoir, in combination with one or more wicking devices that deliver consistent moisture to plant roots. The invention prevents overflow, reduces watering frequency, and may also be adapted for use with hanging plant containers.

### Description of Related Art

Plants are widely grown in homes, offices, gardens, and outdoor spaces for aesthetic, environmental, and health benefits. The vast majority of plant containers incorporate drainage holes to prevent the buildup of excess water in the container, which can cause root rot. This drainage, however, typically requires the use of saucers or trays beneath the container to collect runoff water, which can overflow and damage surfaces if too much water is applied.

Conventional plant saucers are shallow trays positioned underneath a potted plant. When a user waters the plant from above, excess water drains through the container's drainage holes into the saucer. However, several common problems arise with this approach:
Overflow: If too much water is used, it may overflow the saucer, causing water damage to floors, furniture, or other surfaces.
Root Rot Risk: If the plant container sits in a deep puddle of water for too long, the roots can remain saturated, leading to disease, rot, and unpleasant odors.
Inconsistent Watering: Water often passes quickly through dry soil, failing to saturate the soil evenly. This can leave parts of the root system chronically under-watered.

An alternative practice is to place the potted plant in a sink or container filled with water, allowing the soil to soak up moisture from the bottom until fully saturated. Such practices are time-consuming, inconvenient, and especially impractical for large, heavy, or hanging plants. Repetition of this method can be burdensome, and water overflow is difficult to avoid unless the pot is supervised during soaking.

Self-watering containers often integrate a built-in reservoir, from which water is drawn into the potting soil. This can reduce the frequency of watering and help maintain consistent soil moisture. However:
Expense & Limited Sizes: Such containers can be costly and are only available in certain designs and sizes. Further, the user must repot the plant into the specialized container.
Inflexibility: Converting any traditional pot into a self-watering one requires purchasing new containers or retrofitting existing containers at significant cost and inconvenience.

Hanging plant containers pose particular watering challenges. They cannot readily accommodate a saucer underneath since the water drains freely. Users must often climb a ladder or step stool to water from above, letting excess water drip onto the ground or indoor surfaces, which wastes water. In hot climates, frequent watering—sometimes multiple times a day—is required, and water waste can be significant.

Given the above-mentioned drawbacks of conventional watering methods, there is a need for a robust, universal self-watering system that:
Prevents overflow and associated surface damage.
Minimizes the risk of root rot by elevating the plant container above the highest water level.
Provides a stable water reservoir that is easy to refill and maintains consistent moisture for the plant without requiring frequent watering.
Allows any existing plant container including hanging baskets to be quickly adapted into a self-watering system.
Incorporates a wicking device that draws water up from the reservoir to the root zone and optionally accommodates slow-release fertilizer or nutrient inserts.

### SUMMARY OF THE INVENTION

The present invention is directed to a self-watering plant container saucer that incorporates a water reservoir and one or more wicking devices, thereby transforming any conventional plant pot into a self-watering system. The saucer includes:

The saucer features a deep reservoir with raised support portions that elevate the plant container above the bottom of the reservoir. When filled, water remains at a level below the container's main body, ensuring roots are not submerged and preventing root rot. The saucer is also configured to be wider at the top than at the bottom, easing the placement and removal of the plant container. A portion of the top may protrude outward or contain a fill spout, facilitating easy filling of the reservoir without removing the plant.

The raised platform or ridges hold the planter just below the highest fill line, allowing initial water uptake through the container's drainage holes. As the plant absorbs water, the water level falls below the container base, ensuring healthy aeration.

One or more wicking sticks extend from the reservoir into the container's drainage holes. The wicking stick is comprised of an elongate wicking material contained within an elongated slender cage and may include in certain embodiments a slow-release fertilizer, or a bio-degradable material infused with fertilizer, that slowly disintegrates and releases nutrients.

In an alternative embodiment, the wicking material my be comprised of or include a slow release fertilizer.

The wicking material may be shaped and formulated to be rigid for easy insertion into the base of the potted plant with exposed strands or portions extending into the water reservoir. As the wicking material absorbs water, it could then become more flexible.

The saucer and wicking devices are designed to be compatible with any plant container, including those for hanging plants. An optional set of adjustable hooks are configured to attach the saucer to the sides of a hanging basket, enabling self-watering without spillage.

By relying on capillary action through the wicking devices, the plant's soil remains evenly moist, reducing or eliminating the need to water the plant from the top. This method also reduces water waste and prevents overflow of the water reservoir.

In this manner, the invention solves problems with traditional saucers overflow, root rot, and inconsistent watering and replicates the benefits of integrated self-watering pots without requiring the user to repot the plant. The saucer can be used independently or easily attached to a hanging container, offering a flexible, cost-effective, and low-maintenance solution for plant care.

The foregoing embodiments provide an apparatus for self-watering plants with significant advantages and novel improvements over the prior art. These advantages and improvements are further set forth in of the drawings and detailed description of the invention that follows.

### BRIEF DESCRIPTION OF THE DRAWINGS

To provide a more thorough understanding of the present invention and how it may be made and used, reference will be made to the accompanying drawings, in which:

FIG. 1 is a partial cross-sectional side view of a self-watering system for plants in accordance with the principles of the present invention.

FIG. 2 is a perspective top view of the saucer for the self-watering system for plants of FIG. 1.

FIG. 3 is a top view of the saucer for the self-watering system for plants of FIG. 1

FIG. 4 is a side view of the saucer for the self-watering system for plants of FIG. 1.

FIG. 5 is a dimensioned side top and side view of the saucer for the self-watering system for plants of FIG. 1.

FIG. 6 is a perspective top view of different sized saucers in accordance with the present invention in stacked arrangements.

FIGS. 7A and 7B are side views of a support hook for the self-watering system for plants as shown in FIG. 1.

FIG. 8 is a perspective side view of a wicking device in accordance with the present invention as shown in FIG. 1.

FIGS. 9A, 9B, and 9C are end and side views of the wicking device shown in FIG. 8.

### DETAILED DESCRIPTION OF THE INVENTION

Those of ordinary skill in the art will realize that the following description of the present invention is illustrative only and not in any way limiting. Other embodiments of the invention will readily suggest themselves to such skilled persons, including, without limitation, combinations of features of the illustrated embodiments.

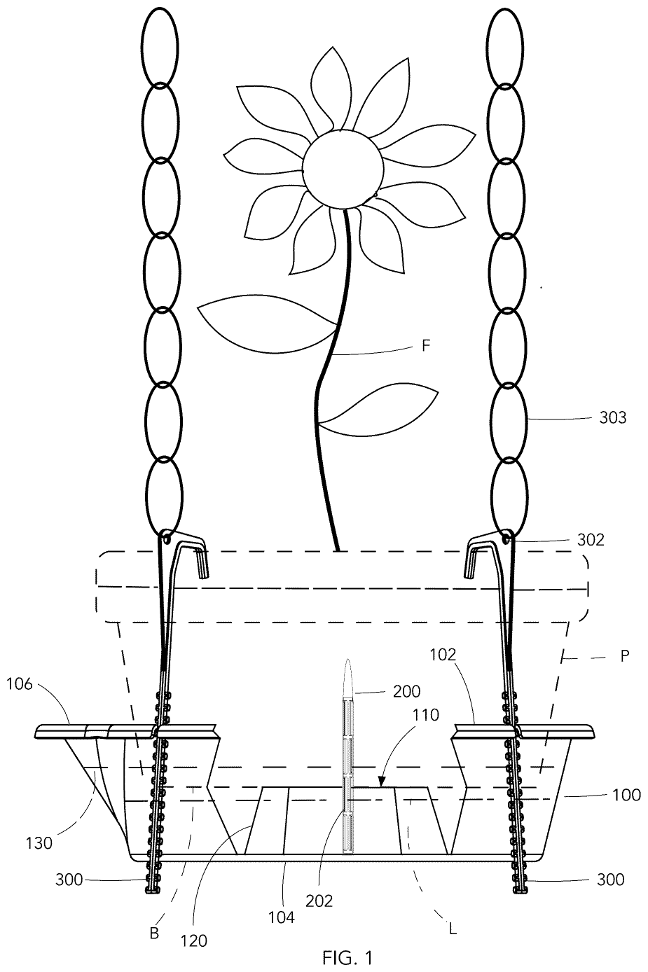

Referring generally to FIG. 1, the self-watering apparatus or system, hereinafter “system”, includes a saucer 100 defining a water reservoir 110, raised support structures 120, and one or more wicking devices 200 that project through drainage holes of a conventional plant basket or pot P. The reservoir may be filled to a desired level—up to a highest fill line 130—to allow initial sub-irrigation and soaking of the base of the pot P and thus roots of the plant F. As moisture is absorbed by the plant F, the water level L falls below the bottom of the container or pot P, preventing the plant roots from sitting in stagnant water.

The saucer 100 is generally wider at the top 102 than at the bottom 104, to facilitate easy placement and removal of a plant pot P. One side of the saucer 100 is provided with an outwardly extending or protruding rim portion that forms a fill spout 106. Thus, the effective diameter of the saucer 100 is wider at the fill spout 106 and further spaced from the pot P than the rest of the top rim 102 of the saucer 100 so as to allow the saucer 100 to be filled with water when the pot P is placed in the saucer 100, thus enabling simple reservoir 110 refilling.

The interior of the saucer 100 defines a relatively deep reservoir 110 with the bottom of the reservoir 110 spaced below the bottom B of the pot P. The pot P is held above the bottom B of the pot P by the plurality of support platforms 120 that extend from the bottom 104 of the saucer 100. The support platforms 120 occupy significantly less space in the reservoir 110 than would otherwise be occupied by the bottom B of the pot P if the bottom B of the pot P were rested upon the bottom 104 of the saucer 110. Thus, the reservoir is capable of holding a substantial volume of water for continuous self-watering of the plant F. In one embodiment, the reservoir depth ranges from about 2 inches to about 6 inches, but other dimensions can be chosen based on pot size, plant size, and watering requirements.

Where the saucer 100 is placed upon a surface, the pot P can simply be placed within the saucer 100 to rest upon the support platforms 120. However, in order to hang the pot P, a plurality of adjustable hooks 300 are employed to couple the saucer 100 to the pot P. Each hook 300 is configured to couple to the top rim 102 of the saucer 100 and extend over the top rim of the pot P. As will be described in more detail, the hooks 300 have equally spaced integrated notches that fit within and are thus coupled to slits in the top rim 102 of the saucer to thereby hold the saucer 100 against the bottom of the pot P. By suspending the saucer 100 beneath the pot P, any water that drains from the pot remains stored in the saucer reservoir 110. If desired, each hook 300 may be provided with a hole 302 (or other attachment device) at its upper end for attaching a chain 303 or other hanging device or structure, such as rope, wire or other materials known in the art, to allow the saucer 100 and pot P to be suspended or hung from an overhead structure. Alternatively, the pot P can suspended or hung from the rim of the pot P with the hooks 300 holding the saucer 100 to the bottom of the pot P.

As further shown in FIG. 1, a wicking device 200 is inserted through a hole in the bottom of the Pot P and into soil contained in the pot P. The wicking device 200 is in the shape of an elongated hollow tube with perforated or cage-like sides and contains a wick 202 formed of a water wicking material that extends the length of the wicking device 200. The wicking device 200 extends from the reservoir 110 through a drainage hole in the pot P and into the soil. As a result, water in the reservoir 110 is pulled by capillary action through the wicking material into the wicking device 200. Water in the wicking device is then dispersed into the surrounding soil contained in the pot P to water the roots of the plant F.

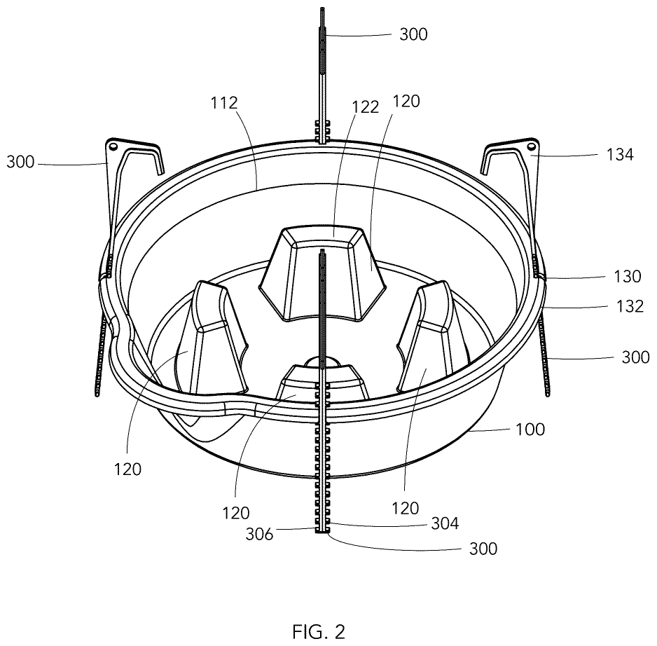

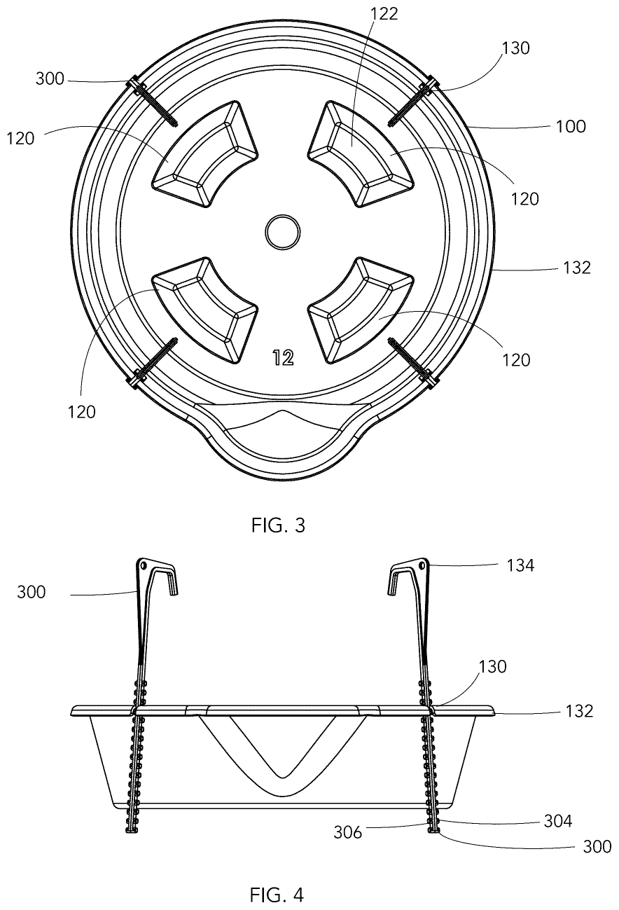

As shown in FIGS. 2, 3, and 4, the support platforms 120 are generally trapezoidal in shape with curved inner and outer surfaces that are concentric to the diameter of the saucer 100. Each support platform 120 defines a flat top surface 122 configure for contacting and supporting the pot P when rested thereon and for creating the reservoir 110 between the bottom of the pot P and the bottom of the saucer 100. In this embodiment, there are four such support platforms 120 equally concentrically spaced within the bottom of the saucer 100, but it is also contemplated that more or fewer such support platforms could also be employed. The support platforms 120 are molded or otherwise formed into the interior of the saucer 100.

Referring again to FIG. 1, the pot P rests on these raised support structures, ensuring:
Stability: The container will not wobble or tip, regardless of whether the reservoir is full or empty.
Vertical Clearance: Drainage holes in the pot P are held above the reservoir base, ensuring that as water is drawn up with the wicking devices, the water level can remain below the bottom of the pot P so as to not submerge the pot's root zone.

As further shown in FIGS. 2, 3, and 4, the saucer 100 includes an indicator or other visible fill line 112 on the interior or exterior wall of the saucer helps users avoid overfilling the saucer 100. This fill line 112 sits just above the top surfaces 122 of the support platforms 120. When the pot P is placed in the saucer 100, initial watering from below soaks the soil until it is saturated, then the water level drops naturally to below the top surfaces 122 of the support platforms 120 as the water is wicked through the wicking device 200 into the soil of the plant F.

The saucer 100 may be constructed of plastic, ceramic, metal, or composite materials resistant to corrosion and capable of supporting a water-filled reservoir plus pot P, soil, and plant weight. Lightweight molded plastic is a preferred material due to cost efficiency, ease of manufacture, and durability. Plastic also lends itself to forming the fill spout of the saucer 100 and integral raised supports platforms 120 in a single molding step.

The reservoir capacity may vary based on the diameter of the saucer and the height of the support platforms chosen. By providing a water reservoir volume that can last several days or weeks, the frequency of needed watering for a healthy plant F is significantly reduced.

As further shown in FIGS. 2, 3, and 4, each hook 300 has a plurality of laterally extending protrusions 304 along its length that form a plurality of equally spaced notches 306. Vertical slits 130 in the outer rim 132 of the saucer 100 are configured to receive the notched portion of a hook 300 so that adjacent protrusions of the hook are placed above and below the outer rim 132 to secure the hook 300 to the outer rim 132 of the saucer 100. With a plurality of vertically spaced protrusions 304 along a length of each hook 300, the distance between the outer rim 132 of the saucer 100 and the upper hook portion 134 can be adjusted to accommodate different heights of pots P and properly secure such pots P to the saucer 100 for proper watering by the wicking device 200.

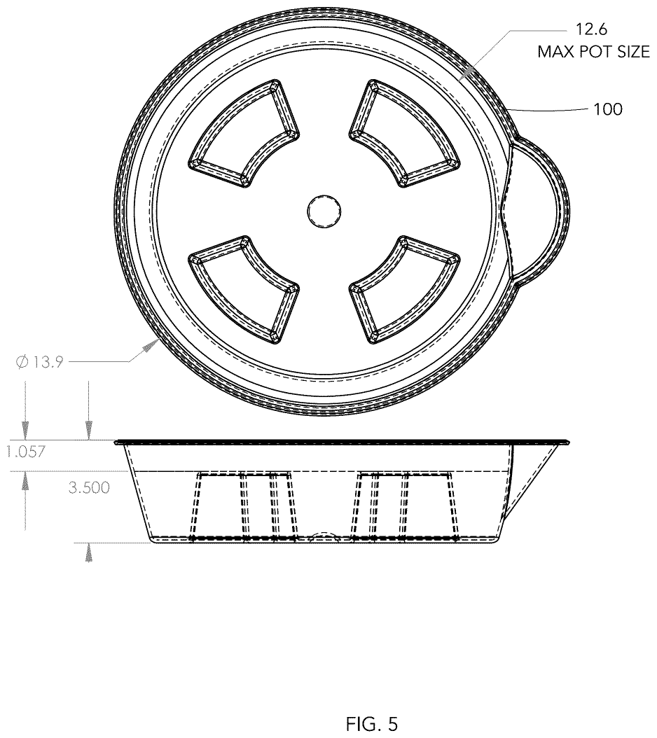

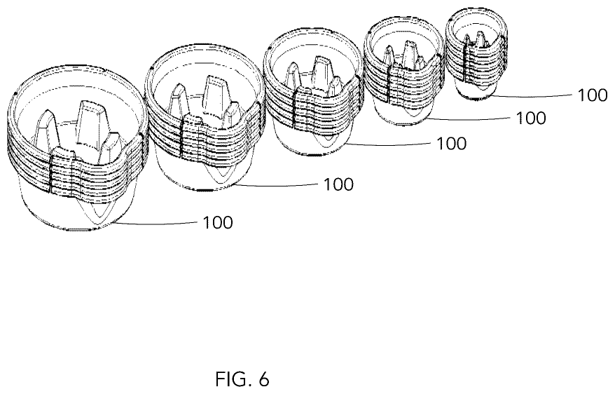

As shown in FIGS. 5 and 6, various sizes of saucers can be formed to accommodate correspondingly different sized pots or baskets. For example and not by way of limitation, as shown in FIG. 5, a saucer 100 with an outer diameter of 13.9 inches is configured to accommodate a maximum outer diameter pot size of 12.6 inches. The height of each support platform may be spaced from the top rim of the saucer by 1.057 inches with a total saucer height of 3.5 inches such that the support platforms are approximately ⅔ of the height of the total height of the saucer. To accommodate a maximum pot size of 10.6 inches, a saucer of 11.8 inch diameter can be formed. In that case, the support platform heights might be spaced 0.932 inches from the top rim with a total saucer height of 3.125 inches. For a maximum pot size of 8.6 inches, the outer diameter of the saucer would be 9.7 inches with total height of 2.75 inches and platform spaced 0.807 inches from the top rim. For a maximum pot size of 6.6 inches, the outer diameter of the saucer would be 7.7 inches with a total height of saucer being 2.375 inches and the support platforms spaced 0.691 inches from the top rim. For a maximum pot size of 4.6 inches, the saucer has an outer diameter of 5.7 inches with a total heigh top 2.125 inches and a platform height spaced 0.775 inches from the top rim.

As shown in FIG. 6, the saucers 100 are configured to be stackable according to their sizes. This allows for convenient shipping and storage of the saucers of the various sizes.

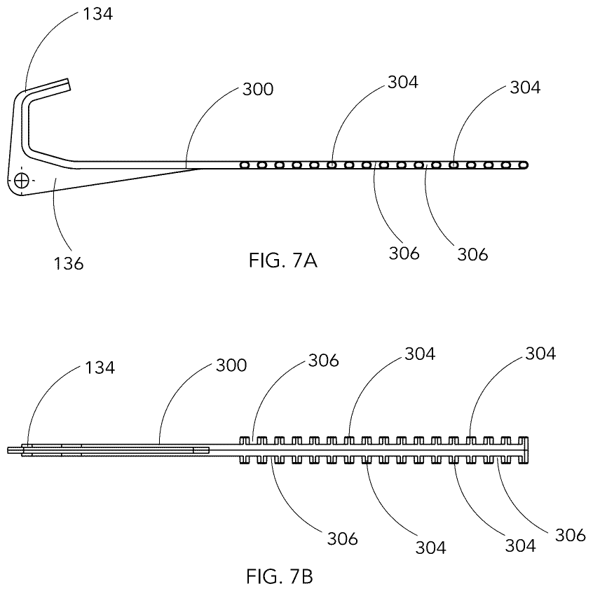

Referring now to FIGS. 7A and 7B, as previously indicated each hook 300 has an upper hook portion 134 and an elongate body portion with a plurality of equally spaced protrusions 304 forming equally spaced notches 306 along its length configured for engaging in the vertical slits in the rim of the saucer as previously shown and described herein. The upper hook portion 134 includes a vertically and outwardly extending fin portion 136. The fin portion 136 extends along the outer surface of the hook 300 from an upper portion of the linear elongate portion of the hook 300 around the upper hook portion 134. The fin portion 136 adds structural integrity and strength to the upper hook portion 134 to prevent the hook portion 134 from failing (i.e., from straightening) under weight of the saucer, water, pot, plant and soil carried by the hook 300.

As previously discussed, each wicking device 200, when inserted into the pot P, extends from the interior of the saucer's reservoir 110 into one or more drainage holes of the plant container P and extends into the soil of the plant P. The wicking device 200 relies on capillary action to transfer water from the reservoir 110 to the plant's soil in order to water the roots of the plant F.

The wicking devices 200 are configured to be easily inserted or removed, enabling the user to customize the level of moisture delivered based on the plant's needs. For example if more watering is needed, a plurality of wicking devices 200 can be inserted into a corresponding number of drainage holes formed in the bottom of the pot P.

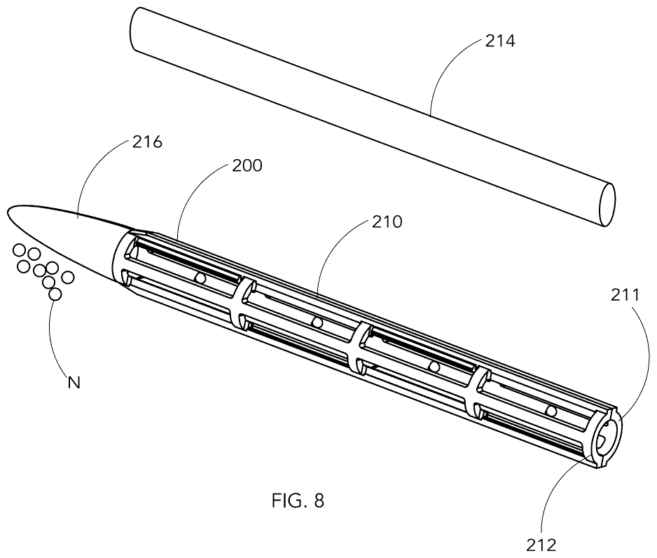

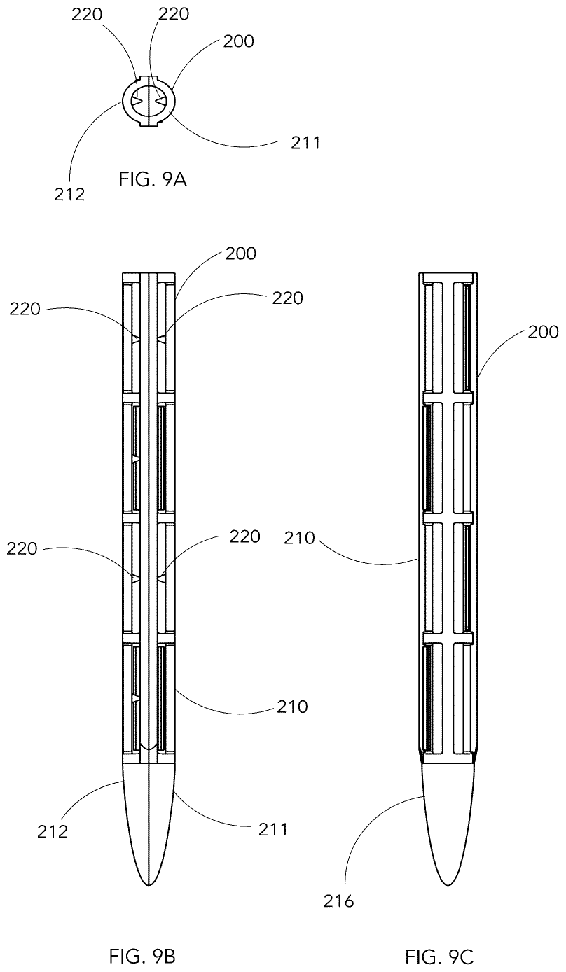

As shown in FIGS. 8 and 9A-9C, the wicking device 200 comprises a wicking cage 210. The wicking cage 210 is formed from two cage halves 211 and 212 that are coupled together in a clamshell fashion and configured to be snap fit together. The wicking cage essentially forms a hollow tubular structure that is formed from plastic, wire mesh, or a similar rigid material. Inside the cage, a wicking material 214 of cotton, polyester, or other absorbent material is positioned to provide a capillary conduit for water. The wicking cage 210 includes a plurality of inwardly extending pointed protrusions 220 configured to engage with the wicking material when the wicking cage is closed around the wicking material 214 to hold and retain the wicking material 214 within the wicking cage 210. The wicking cage may be molded from plastic or formed from other materials known in the art.

A shown in FIG. 8, the wicking cage 212 may include a compartment 216 that holds slow-release fertilizer pellets N, tablets, or a stick. As water travels through the wicking material 214, nutrients in the fertilizer N dissolve gradually and feed the plant. The wicking material 214 may be of a length approximately equal to a length of the cage 212 or be of a length that is substantially longer than the cage 212 (e.g., double or triple the length of the cage 212) so that the exposed end of the wicking material 214 will rest on the bottom of the reservoir and thus have a substantial portion of the wicking material 214 submerged in water in the bottom of the reservoir.

Referring again to FIG. 1, the bottom end of the wicking device 200 is configured to rest on the bottom of the reservoir, while the top end protrudes into the plant container through its drainage hole. Alternatively, the wicking material 214 may extend from the bottom of the wicking device 200 to rest on the bottom of the reservoir. The wicking device 200 and thus the wicking material 214 thus becomes partially embedded in the potting soil, delivering water directly to the root zone of the plant F.

In another embodiment, the wicking device may be formed from a bio-degradable stick of material such as coir coconut fiber, compressed peat, or a corn-based polymer. Moreover, fertilizer can be infused within the wicking device and/or the wicking material to release nutrients into the soil as it gradually decomposes. In this embodiment, the need for a cage can be eliminated as well as a need for a fertilizer compartment thereby reducing plastic waste. The stick is rigid enough to be pushed through the container's drainage hole, with its bottom end resting in the saucer water.

In yet another embodiment, a composite wick may be formed by bonding an absorbent fiber e.g., cellulose or cotton with a slow-release fertilizer and a water-insoluble but biodegradable stiffener. A wide variety of materials can be used for water-wicking (capillary action) in plant-watering applications. In general, good water-wicking materials are those that effectively draw and transport water through capillary action, are durable enough for repeated use (or intentionally biodegradable, if desired), and do not introduce harmful contaminants into the soil. For example the wicking material may be formed from cotton or natural fibers, polyester, nylon or propylene fibers, felt or capillary matting, or cellulose-based materials.

It should be noted that the upper portion of the wick, which enters the container, might be slightly larger in diameter to ensure a snug fit in the drainage hole, maintaining a steady flow of water. The lower portion may be more slender, extending freely into the reservoir. Users can trim the wick to suit different reservoir depths or pot sizes.

As previously mentioned, the self-watering system of the present invention includes means for prevention of water overflow and root rot. The fill line and flared top of the saucer ensure that water remains contained. Users can add water to the reservoir through the protruding spout or directly over the lip, stopping at or below the fill line. Any overflow that might occur during initial watering from the top of the plant container is collected in the reservoir, where it can later be drawn up by the wicking device.

A key advantage of the invention is that the plant pot does not remain in standing water once the reservoir level drops below the container's base. This maintains healthy aeration around the roots, minimizing the risk of rot and associated odors.

The present invention also has the advantage of adapting the saucer for use in hanging baskets. For hanging plants, the attachment system comprising adjustable hooks or brackets can be added to the saucer. These hooks latch onto the saucer rim with integrated notches. Each hook terminates in a hook portion that can be secured onto the lip of the pot or hanging basket. By suspending the saucer beneath the pot or basket, any water that drains out remains stored in the saucer reservoir.

Users can fill the reservoir by pouring water into the saucer's fill spout, into the plant until the water adequately drains into the saucer. Any water in the saucer is then wicked upward into the soil, requiring significantly fewer overhead watering sessions. Moreover, excess water no longer drips onto the floor below, reducing mess and waste.

In certain alternative embodiments, the saucer could be subdivided into multiple compartments, allowing the user to separate fertilizer solutions from plain water, or to use different wick materials side by side for plants with varying moisture requirements.

It is also contemplated that a float gauge or similar water level indicator can be integrated, offering visual feedback of reservoir depth without removing the pot or visually inspecting the inside of the saucer.

As previously shown and described, the saucers can be nested or stacked for retail packaging and shipping convenience, making them cost-effective for large-scale distribution.

To use the self-watering system of the present invention, a user places the saucer on a stable surface or attaches it to a hanging basket via hooks. One or more wicking devices are inserted into the drainage holes of the plant container, ensuring that the wick extends from the bottom of the plant container sufficient to reach the bottom of the reservoir. As the plant container is placed in the saucer and the wicking devices contact the bottom of the reservoir, the wicking devices are further pushed into the plant soil so that the bottom of each wicking device rests upon the bottom of the reservoir. This ensures that the wicking devices can still wick water from the reservoir even when the water level is low.

For initial water filling, users fill the reservoir with water up to or slightly below the fill line. The soil may also be watered from above initially to ensure thorough saturation. Thereafter, users only need to periodically monitor the water level in the reservoir. As the water level drops, users can then refill as needed through the spout. In addition, users can periodically replace or replenish wicking materials or fertilizers when necessary, e.g., every few months, depending on plant needs.

The advantages of the self-watering system of the present invention include:
Reduced Frequency of Watering: The reservoir provides a consistent water supply.
Prevention of Overflow: Water is contained within the saucer, preventing damage to floors or furniture.
Minimized Root Rot: The design prevents the plant container from continually sitting in water.
Adaptability: Fits most conventional plant containers, including hanging baskets.

Initial testing with common indoor houseplants and outdoor potted plants has demonstrated that plants placed on the self-watering saucer with a wicking device maintained even soil moisture over a period of several weeks, requiring fewer manual waterings. Additionally, no water leakage was observed below the saucer in normal use. The wicking mechanism successfully delivered water without causing root rot, as the reservoir level naturally remained below the container base after initial saturation. In addition, plants using the self-watering system of the present invention remained healthier and grew larger than similar plants using traditional top only watering methods.

While the self-watering systems and water wicking devices of the present invention have been described with reference to particular embodiments, those of skill in the art will appreciate that other similarly configured embodiments will readily suggest themselves upon an understanding of the principles of the present invention. Thus, the present invention embodied in the several embodiments of self-watering systems and water wicking devices as set forth in the specification and drawings and appended claims are not limited to the features of the specific embodiments. For example, the self-watering systems and water wicking devices could be configured to have a different overall shapes, sizes or construction and/or be adapted to be used with any plant growing systems or devices but using the same principles of the present invention. Such variations, adaptations, and combinations of features of the various embodiments are intended to be within the scope of the claims.

Accordingly, the illustrated embodiments of this invention are not limited to any particular individual feature disclosed herein but include combinations of them distinguished from the prior art in their structures, functions, and/or results achieved. Features of the invention have been broadly described so that the detailed descriptions that follow may be better understood, and in order that the contributions of this invention to the arts may be better appreciated. Those skilled in the art who have the benefit of this invention, its teachings, and suggestions will appreciate that the concepts of this disclosure may be used as a creative basis for designing other structures, methods and systems for carrying out and practicing the present invention.

While there have been described various embodiments of the present invention, those skilled in the art will recognize that other and further changes and modifications may be made thereto without department from the spirit of the invention, and it is intended to claim all such changes and modifications that fall within the true scope of the invention. It is also understood that, as used herein and in the appended claims, the singular forms “a,” “an,” and “the” include plural reference, unless the context clearly dictates otherwise.

Unless defined otherwise, all technical and scientific terms used herein have the same meanings as commonly understood by one of ordinary skill in the art to which this invention belongs. While various methods and structures of the present invention are described herein, any methods or structures similar or equivalent to those described herein may be used in the practice or testing of the present invention. All references cited herein are incorporated by reference in their entirety and for all purposes. In addition, while the foregoing advantages of the present invention are manifested in the illustrated embodiments of the invention, a variety of changes can be made to the configuration, design and construction of the invention to achieve those advantages including combinations of components of the various embodiments. Hence, reference herein to specific details of the structure and function of the present invention is by way of example only and not by way of limitation.

The following claims are presented by way of example only and are not intended to limit the scope of the invention. The invention encompasses numerous variations, alternatives, modifications, and equivalents as will be apparent to those skilled in the art.

1. A self-watering system for a plant container, comprising:
a saucer having a bottom portion and an upper rim portion, said saucer defining a reservoir configured to hold water;
one or more raised support structures within the saucer configured to elevate the plant container above a bottom surface of the reservoir; and
at least one wicking device configured to extend from the reservoir through a hole of the plant container, wherein the wicking device is configured to draw water from the reservoir into the plant container, thereby enabling self-watering from the reservoir to the plant container, and wherein the wicking device is bio-degradable and infused with slow-release fertilizer.

2. The system of claim 1, wherein the saucer further comprises a fill spout protruding from a top portion of the saucer, enabling the introduction of water into the reservoir without lifting or moving the plant container.

3. The system of claim 1, wherein the raised support structures are integrally molded platforms, upwardly extending from the bottom surface of the reservoir.

4. The system of claim 1, wherein the wicking device comprises a tubular cage and a wicking material housed within the tubular cage.

5. The system of claim 4, wherein the tubular cage further comprises a compartment for containing slow-release fertilizer.

6. (canceled)

7. The system of claim 1, wherein the saucer is formed of a lightweight plastic and configured for nesting multiple saucers for storage or transportation.

8. The system of claim 1, further comprising a water fill line in the reservoir.

9. (canceled)

10. (canceled)

11. The system of claim 1, further comprising a plurality of saucers, each configured to fit a plant container of a particular size from approximately 4 inches to 18 inches in diameter.

12. The system of claim 1, further comprising a plurality of adjustable hooks, wherein the adjustable hooks include a length-adjustment portion configured to attach to the upper rim portion of the saucer and an upper hook portion configured to attach to a rim of the plant container.

13. The system of claim 12, wherein the upper rim portion of the saucer includes a plurality of vertical slits, each configured for receiving and retaining the length-adjustment portion of the plurality of hooks.

14. The system of claim 13, wherein the length-adjustment portion of each of the plurality of hooks is comprised of a plurality of laterally extending protrusions defining a plurality of notches therein between.

15. The system of claim 1, wherein the wicking material comprises a porous material selected from the group consisting of cotton, polyester, nylon, cellulosic fiber, or combinations thereof.

16. (canceled)

17. The system of claim 16, further comprising a plurality of inwardly extending protrusions in the tubular cage configured for retaining the wicking material therein.

18. The system of claim 12, wherein the plurality of adjustable hooks each include a laterally extending fin around the upper hook portion configured for adding hanging strength to the upper hook portion.

19. (canceled)

20. (canceled)

21. A self-watering system for a plant container, comprising:
a saucer having a bottom portion and an upper rim portion, said saucer defining a reservoir configured to hold water, said saucer having a plurality of attachment points along its rim;
a set of adjustable hooks attachable to the attachment points, the hooks configured to engage a lip or rim of a plant container, thereby suspending the saucer beneath the plant container;
one or more raised support structures within the saucer configured to elevate the plant container above a bottom surface of the reservoir; and
at least one wicking device configured to extend from the reservoir through a hole of the plant container, wherein the wicking device is configured to draw water from the reservoir into the plant container, thereby enabling self-watering from the reservoir to the plant container.
